(19) United States
(12) Patent Application Publication
(10) Pub. No.: US 2026/0307068 A1
(43) Pub. Date: Oct. 8, 2026

(54) PIPETTE TIP AND MOUNTING SHAFT WITH REAR VENTING FEATURE

(71) Applicant: Integra Biosciences AG, Zizers (CH)

(72) Inventors: Christoph Andreas Mauracher, Felsberg (CH); Lukas Wielatt, Chur (CH); Noel Pasquier, Landquart (CH)

(73) Assignee: Integra Biosciences AG, Zizers (CH)

(21) Appl. No.: 19/467,045

(22) Filed: Feb. 2, 2026

Related U.S. Application Data
(60) Provisional application No. 63/785,191, filed on Apr. 8, 2025.

(51) Int. Cl. B01L 3/02

(52) U.S. Cl. CPC B01L 3/0279; B01L 3/0217; B01L 2200/025; B01L 2200/0684; B01L 2200/0689; B01L 2200/087; B01L 2300/0832; B01L 2300/123; B01L 2400/0478

(57) ABSTRACT

A pipette system includes a tip mounting shaft with an upper locking section having a stop, a lower sealing area, and a shaft head. The lower sealing area provides a circumferential sealing surface, and the shaft head comprises one or more grooves formed therein. A pipette tip of the system includes a barrel having a lower opening through which liquid is aspirated and dispensed, a collar, an upper opening for receiving the tip mounting shaft, and a lower end. The tip further includes a circumferential tip shoulder and means for sealing against the lower sealing area proximate the one or more grooves. The one or more grooves are configured to permit a flow of air to enter into the pipette tip barrel through the upper opening in the collar during an ejection process of the pipette system.

### CROSS-REFERENCE TO RELATED PATENT APPLICATION

The present application claims the benefit of U.S. Provisional Application Serial No. 63/785,191, filed Apr. 8, 2025, which is incorporated by reference herein in its entirety.

### FIELD OF THE INVENTION

The invention relates to improvements in handheld pipettes and automated liquid handling systems. More specifically, the invention relates to the configuration of disposable pipette tips and mounting shafts and provides robust sealing engagement with reduced air speeds at the orifice side of the pipette tip during an ejection process, preventing the aerosolization of the remnant liquids in or at the orifice side of the pipette tip.

### BACKGROUND OF THE INVENTION

The use of disposable pipette tips with handheld pipettors and automated liquid handling systems is well known. Disposable pipette tips enable repeated use of pipetting systems to transfer liquid reagents or liquid samples without carryover contamination. Disposable pipette tips are typically formed of a plastic material, such as polypropylene, and have a hollow, elongated, generally conical shape. The upper end of the pipette tip typically includes a collar that is mounted to a mounting shaft on the pipetting device. The mounting shaft is sometimes called the tip fitting. The mounting shaft or tip fitting includes an internal bore through which air is displaced in order to aspirate a liquid sample or reagent into the barrel of the pipette tip and then dispense the liquid sample or reagent from the pipette tip normally in another location. The distal end of the pipette tip has a small opening through which the liquid sample or reagent is received as it is aspirated into the barrel of the pipette tip and then dispensed.

Disposable pipette tips have historically relied on tapered fits between the mounting shaft and the pipette collar, as well as sealing rings on the inside circumference of the pipette collar, to secure and seal the pipette tips to the mounting shaft. Sometimes an O-ring on the mounting shaft is used to seal against the pipette tip. With tapered fits, the seal between the mounting shaft and the disposable tip is achieved by pushing the tapered mounting shaft into the tapered collar until the mounting shaft wedges into the tip. At this point, a seal is reached between the frustoconical tip collar and the mounting shaft as a result of crushing a sealing ring on the pipette tip (or an O-ring on the mounting shaft) and/or stretching the diameter of the pipette tip.

Various systems have been devised to provide proper sealing and stability without requiring excessive insertion and ejection forces. The assignee of the present application has developed a reliable, ergonomic pipette tip mounting system described generally in U.S. Patent No. 7,662,343 entitled "Locking Pipette Tip and Mounting Shaft," issuing on February 16, 2010; U.S. Patent No. 7,662,344, also issuing on February 12, 2010 and entitled "Locking Pipette Tip and Mounting Shaft;” U.S. Patent No. 8,277,757 entitled “Pipette Tip Mounting Shaft” and issuing on October 2, 2012; U.S. Patent No. 8,501,118 entitled “Disposable Pipette Tip” and issuing on August 6, 2013; U.S. Patent No. 8,877,513 entitled “Method of Using a Disposable Pipette Tip” and issuing on November 4, 2014; and U.S. Patent No. 9,333,500 entitled “Locking Pipette Tip and Mounting Shaft in a Handheld Manual Pipette” and issuing on May 1, 2016, all incorporated herein by reference. The assignee of the present application has also filed U.S. Pat. Appl. No. 18/601,304, entitled “Pipette Tip and Mounting Shaft,” and U.S. Pat. Appl. No. 18/601,382, entitled “Pipette Tips and Rack System for Liquid Handling Equipment,” which are also incorporated by reference.

In these incorporated patents and patent applications owned by the assignee, the tip mounting shaft includes a locking section having circumferentially spaced outwardly extending locking lobes located above a stop which consists of a step spanning between the locking section of the mounting shaft and a lower sealing section of the mounting shaft having a smaller diameter. When the mounting shaft is fully inserted into the collar of a mating disposable pipette tip, the collar of the tip locks onto the mounting shaft. The bore of the pipette tip includes a circumferential shelf or shoulder separating its upper collar from the tip sealing area which is located on the circumferential shelf in more recent designs or below in the barrel of the tip in older designs. The tip collar preferably includes a locking ring at or near the upper opening of the collar through which the mounting shaft is inserted. The dimensions of the collar, and in particular the distance between the circumferential shoulder and the locking ring, are selected to match the dimensions of the mounting shaft between the stop and a catch surface of the upper end of the locking lobes, thus locking the pipette tip in a secure, reliable position and orientation. The locking lobes include an inclining ramp portion that generally flexes and distorts the pipette tip collar out of round as the mounting shaft is inserted into the pipette tip, rather than stretching the tip collar, thereby reducing the amount of insertion force needed to mount the tip.

As described in the above incorporated patents and applications owned by assignee, the combination of the locking lobes and the stop on the mounting shaft results in an ergonomic, over-center locking engagement that provides acoustic and tactile feedback to the user of a handheld pipette indicating that the disposable pipette tip is approaching and has been fully engaged on the mounting shaft. As the mounting shaft is pushed into the tip collar, the first point of contact is where the leading edge of the mounting shaft, i.e., the lower sealing section, enters through the circumferential shoulder in the pipette tip and contacts the sealing region in the tip barrel, or in the case of the pending applications contacts the reverse cup seal at the circumferential shoulder. As the mounting shaft is further depressed into the pipette tip bore, the interference for the seal increases and the inclining ramp areas of the locking lobes on the mounting shaft engage the tip collar, and in particular the locking ring around the opening of the tip collar, to distort the upper portion of the collar out-of-round. While the overall insertion force is relatively light and ergonomic compared to tip fittings with different configurations, the force increases noticeably and provides tactile feedback to the user that the tip is almost fully mounted. Insertion force is generally required until the stop member on the mounting shaft engages the circumferential shoulder on the pipette tip to abruptly stop further movement of the mounting shaft into the tip. At this point the lobes have snapped under the locking ring on the collar and the stop has hit the circumferential shelf on the tip, thus providing the user tactile feedback not to use additional, excessive force to mount the tip. These interrelated mounting conditions result in a secure, stable mount with consistent sealing. While automated pipette systems do not rely on tactile feedback to determine when the tip is properly mounted, the configuration of assignee’s pipette tips and mounting shafts provides reliable, robust sealing. For example, if a tip rack bends when the tips are being mounted, the lobed-mounting shaft configuration helps to ensure that all the tips are properly mounted and at the appropriate height relative to the pipetting head.

While the above tip mounting system described in assignee’s incorporated patents and application has provided a significant advancement in the art and the reduction of insertion forces, it is desirable to further control the sealing means between the pipette tip and the mounting shaft so that creation of unwanted aerosols and liquid jetting of liquid that remains in the nozzle of the pipette tip is avoided during an ejection process in which the pipette tip is demounted from the mounting shaft. Because existing tip systems feature pipette tips fabricated from malleable polypropylene, the seal or seal region on the tip remains engaged with the mounting shaft at least initially during tip ejection. As the friction force is overcome during tip ejection, the tip then disengages from the fitting suddenly and the build-up of penitential energy results in the sudden release at very high speeds. It has been found that significant negative pressure is created inside the pipette tips under these circumstances. This negative pressure is then relieved by ambient air accelerating through the bottom orifice of the pipette tip, causing an air jet entering through the orifice leading to the formation of aerosols and microdroplets of remnant liquids carried into the tip barrel. Such aerosols may contaminate both the inside surface of the tip and the mounting shaft as well as the lab spaces and operators nearby. The present inventors have therefore endeavored to provide a pipetting system with structural features that provide a controlled ejection process and the prevention of the formation of aerosols for both automated and manually operated pipetting systems.

### SUMMARY

According to an exemplary implementation of the present disclosure, a pipette system comprising a tip mounting shaft and a disposable pipette tip is provided. The tip mounting shaft includes an upper locking section having a stop and a lower sealing area located immediately below the stop, and a shaft head extending down from and contiguous with the lower sealing area. The lower sealing area provides a circumferential sealing surface, and the shaft head comprises one or more grooves positioned circumferentially about the shaft head The disposable pipette tip includes a barrel having a lower opening through which liquid is aspirated into the barrel and dispensed from the barrel. The diameter of the lower opening is less than the diameter of the barrel at an upper end of the barrel. The disposable pipette tip further includes a collar having a continuous inner surface with a circular circumference in its relaxed state, an upper opening for receiving the tip mounting shaft, and a lower end with an inside diameter that is larger than an inside diameter of the upper end of the barrel. The pipette tip further includes a circumferential tip shoulder connecting the lower end of the collar to the upper end of the barrel and means for sealing against the circumferential sealing surface below the stop on the mounting shaft immediately above the one or more grooves on the shaft head.. The one or more grooves are configured to permit a flow of air to enter into the pipette tip barrel through the upper opening in the collar during an ejection process of the pipette tip.

Preferably, the one or more grooves comprises a plurality of grooves positioned at intervals circumferentially about the lower sealing area, for example at equal intervals circumferentially about the lower sealing area. In the preferred embodiment of the invention, the shaft head has six grooves positioned at 60° intervals circumferentially .

In the disclosed exemplary embodiment, the sealing means for sealing against the lower sealing area proximate the one or more grooves comprises a circular cantilever sealing ring having an annular wall extending from the tip shoulder toward the collar opening for laterally engaging and sealing against the lower sealing area of the mounting shaft when the tip is fully mounted to the mounting shaft. The annular wall has a top edge that abuts the stop on the tip mounting shaft when the tip is fully mounted to the shaft. The angle of the stop relative to a longitudinal axis of the tip mounting shaft ranges from 45° to 110°, but is preferably 90° which has been found to facilitate robust sealing in a wide array of circumstances. Each of the one or more grooves terminates in a lip positioned below the stop that laterally engages the circular cantilever sealing ring. The disposable pipette tip further comprises a circumferential stabilization ring encircling the inside surface of the barrel and extending inward from the inside surface of the barrel. The circumferential stabilization ring is located below said sealing means for sealing the disposable pipette tip. The terminating lip of each of the one or more grooves is configured to abut the circumferential stabilization ring of the pipette tip when the tip is fully mounted to the shaft.

In the exemplary embodiment, the upper locking section of the tip mounting shaft further comprises a plurality of outwardly extending lobes, and the pipette tip further comprises an upper locking and stabilization ring extending inward from the continuous inner surface of the collar to lock over the lobes. The upper locking and stabilization ring extends around the entire circumference of the collar or substantially around the entire circumference of the collar and is located at a rim of the upper opening of the collar and above the circumferential shoulder. The collar of the disposable pipette tip is sufficiently flexible to distort outwardly at the lobes on the mounting shaft when the tip is being mounted and relaxes as the locking and stabilization ring clears the lobes during the mounting process. The locking and stabilization ring is configured to abut the mounting shaft above the lobes and stabilize the tip when the tip is fully mounted to the shaft. When the disposable pipette tip is ejected from the tip mounting shaft, the locking and stabilization ring in the collar of the disposable pipette tip engages the lobes and clears the peaks of the lobes to provide haptic feedback to a user.

In another aspect, the invention pertains to a disposable pipette tip configured to reliably seal against a pipette mounting shaft having the preferred structure identified above and also facilitate reduced ejection speed when the grooves are exposed thereby reducing maximum ejection pressure and microdroplet formation. The disposable pipette tip includes a barrel having a lower opening through which liquid is aspirated into the barrel and dispensed from the barrel, wherein the diameter of the lower opening is less than the diameter of the barrel at an upper end of the barrel. The collar has a continuous inner surface with a circular circumference in its relaxed state, an upper opening for receiving the tip mounting shaft, and a lower end with an inside diameter that is larger than an inside diameter of the upper end of the barrel. The disposable pipette tip further includes a circumferential tip shoulder connecting the lower end of the collar to the upper end of the barrel and means for sealing against the lower sealing area proximate the one or more grooves on the mounting shaft below the stop on the mounting shaft. The sealing means permits the flow of air to enter via the one or more grooves into the pipette tip barrel through the upper opening in the collar during the ejection of the tip.

In the disclosed embodiment, said sealing means for sealing against the lower sealing area proximate the one or more grooves comprises a circular cantilever sealing ring having an annular wall extending from the tip shoulder toward the collar opening for laterally engaging and sealing against the lower sealing area of the mounting shaft when the tip is fully mounted to the mounting shaft, said annular wall having a top edge that abuts the stop on the tip mounting shaft when the tip is fully mounted to the shaft. The disposable pipette tip also comprises a circumferential stabilization ring encircling the inside surface of the barrel and extending inward from the inside surface of the barrel below said sealing means for sealing the disposable pipette tip.

The disposable pipette tip further comprises an upper locking and stabilization ring extending inward from the continuous inner surface of the collar to engage a plurality of outwardly extending lobes on the upper locking section of the tip mounting shaft. The upper locking and stabilization ring extends around the entire circumference of the collar or substantially around the entire circumference of the collar and is located at a rim of the upper opening of the collar and above the circumferential tip shoulder. The collar is sufficiently flexible to distort outwardly at the lobes on the mounting shaft when the locking and stabilization ring passes over the lobes on the mounting shaft and to relax as the locking and stabilization ring clears the lobes during the mounting process. The upper locking and stabilization ring is configured to abut the mounting shaft above the lobes and stabilize the tip when the tip is fully mounted to the shaft.

When the disposable pipette tip is ejected from the tip mounting shaft, the locking ring and stabilization ring in the collar of the disposable pipette tip engages the lobes and clears the peaks of the lobes to provide haptic feedback to a user while the lateral seal on the tip moves downward along the lower sealing surface of the mounting shaft. The speed of the pipette tip relative to the mounting shaft slows as the lobes are cleared (see FIG. 12). The relative spacing between the annular wall of the cantilever sealing ring on the tip and the locking and stabilization ring is selected so that the annular wall approaches and impinges the terminating lip of grooves on the mounting shaft while the relative ejection speed of the tip is relatively slow. Accordingly, the configuration of the pipette tip facilitates reduced ejection speed when the grooves are exposed thereby reducing maximum ejection pressure and microdroplet formation.

### BRIEF DESCRIPTION OF THE DRAWINGS

FIG. 1A is a perspective view of a handheld, electronic air displacement pipette incorporating the concepts of the present invention.

FIG. 1B is a manually assisted 384-well robotic pipetting instrument using mounting shafts and pipette tips configured to offset engagement of the locking ring over mounting shaft lobes and the sealing of the tip against the mounting shaft, in accordance with the present invention.

FIG. 1C is a perspective view of an exemplary handheld multichannel pipette using the invention.

FIG. 2 is a perspective view showing a disposable pipette tip and tip mounting shaft constructed in accordance with the invention.

FIG. 3 is a side elevational view of the mounting shaft and pipette tip shown in FIG. 2.

FIGS. 4 and 5 are additional perspective views depicting the tip mounting shaft having venting grooves constructed in accordance with the invention.

FIG. 6 is a top view of the pipette tip and tip mounting shaft at the onset of sealing.

FIG. 7 is a transparent side elevational view of the pipette tip and tip mounting shaft at the onset of sealing.

FIG. 8 is a side cross-sectional view taken along the line A-A in FIG. 6.

FIG. 9 a side cross-sectional view taken along the line B-B in FIG. 6.

FIG. 10 is a bottom cross-sectional view taken along the line F-F in FIG. 8.

FIG. 11A is a detailed quarter sectional view showing the mounting shaft inserted into the pipette tip in a fully sealed configuration.

FIG. 11B is a view similar to FIG. 11A in which an ejection process of the pipette tip has commenced and the seal between the mounting shaft and the pipette tip is broken.

FIG. 11C is a view similar to FIGS. 11A-11B in which the ejection process has continued and air is permitted to flow into the pipette tip via the venting grooves.

FIG. 12 is a plot depicting the travel speed of the pipette tip as it is ejected from the mounting shaft configured according to the present invention.

FIG. 13 is a plot comparing the travel speeds of pipette tips as they are ejected from a prior art mounting shaft and a mounting shaft having venting grooves configured according to the present invention.

FIG. 14 is a diagram depicting flow velocities of air around different regions of the pipette tip during an ejection process with a mounting shaft having venting grooves constructed in accordance with the invention.

FIG. 15 is a plot comparing the flow velocities of air entering the orifices of pipette tips as they are ejected from a prior art mounting shaft and a mounting shaft having venting grooves configured according to the present invention.

FIGS. 16A-16E are a series of diagrams depicting the generation of aerosols during an ejection operation of a prior art friction fitted pipette tip system.

FIGS. 17A-17D are another series of diagrams depicting an improvement in the generation of aerosols during an ejection operation of the prior art friction fitted pipette tip system modified to include a venting hole in the collar of the tip.

FIGS. 18A-18D are yet another series of diagrams depicting a further improvement in the generation of aerosols during an ejection operation of a pipette system according to the systems and methods of the present disclosure.

### DETAILED DESCRIPTION

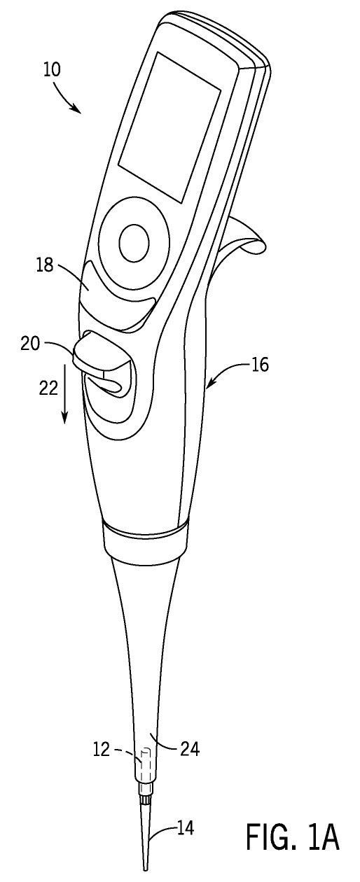

FIG. 1A illustrates a handheld, electronic air displacement pipette 10 that incorporates a tip mounting shaft 12 constructed in accordance with an exemplary embodiment of the invention. A disposable pipette tip 14 also constructed in accordance with the invention mounts to the pipette tip mounting shaft 12. Pipette tip mounting shafts 12 are also commonly referred to as tip fittings.

The handheld pipette 10 includes a housing 16 designed to be held in the palm of the user. Internal components of the pipette (not shown) drive a piston that extends through a seal assembly to displace air within an aspiration and dispensing cylinder. The tip mounting shaft 12 is threaded or otherwise attached to the lower end of the pipette 10 such that it is in fluid communication with the aspiration and dispensing chamber. The attachment of the mounting shaft 12 to the pipette is not particularly relevant to the concepts of the invention, and is well known in the art. A run button 18 is provided for the user to instruct the pipette to aspirate and dispense. The pipette 10 also includes a lever or ejection button 20 actuated in the direction of arrow 22 to move an ejection mechanism sleeve 24 downward to eject the disposable pipette tip 14 from the mounting shaft 12. The disposable pipette tip 14 is mounted for use by inserting the mounting shaft 12 on the pipette 10 into a collar of the disposable tip 14.

FIG. 1B illustrates a manually directed, 384-channel robotic pipetting system 11. Specifics of how the robotic pipetting system 11 operates are disclosed in U.S. Pat. No. 8,367,022, entitled “Unintended Motion Control for Manually Directed Multi-Channel Electronic Pipettor,” by Warhurst et al., issuing on Feb. 5, 2013 and incorporated herein by reference; and U.S. Pat. No. 8,372,356, entitled “Manually Directed, Multi-Channel Electronic Pipetting System,” by Warhurst et al., issuing on Feb. 12, 2013, and also incorporated herein by reference. The invention is also useful in connection with manual pipettes, electronic or manual multi-channel handheld pipettes (see FIG. 1C). Briefly, the robotic pipetting system 11 of FIG. 1B is shown with an array of 384 disposable pipette tips 14 mounted onto an array (16 x 24) of mounting shafts 12 on a pipetting head attached to the system 10. The tip mounting shafts 12 and the disposable pipette tips 14 are constructed as discussed below. When mounting an array of pipette tips 14 simultaneously onto an array of mounting shafts 12, the required cumulative insertion force is significantly greater than with a single channel, handheld pipette or even an 8-, 12- or 16-channel handheld pipette. In fact, the cumulative insertion force to attach 384 tips simultaneously is significantly more than 96 tips. The robotic pipetting system 11 in FIG. 1B has a vertical drive mechanism that is used to raise and lower the pipetting head and generate enough force for simultaneous insertion into 96 or 384 tips. It is known in robotic pipetting systems, whether manually directed like the system 11 in FIG. 1B, or fully automated like many other laboratory liquid handling systems, to have a vertical drive mechanism to raise and lower the pipetting head with enough force to simultaneously mount 96 or 384 pipette tips.

The robotic pipetting system 11 in FIG. 1B has a flat deck 17 supporting a right-side nesting receptacle 19 and a left-side nesting receptacle 21. The nesting receptacles 19, 21 are designed to hold microtiter plates, reagent reservoirs, or pipette tip racks in known locations on the deck 17. The nesting receptacles 19, 21 desirably have dimensions defined by SBS standards as is known in the art. FIG. 1B shows a pipette tip rack system 20 in the left-side nesting receptacle 21. The pipette tip rack 20 holds 384 pipette tips which in FIG. 1 have been mounted to a pipetting head attached to the carriage 22 of the robotic pipetting system 11. The carriage 22 in turn is mounted to a tower 24. In some systems, the pipetting head is replaceable, which would enable the customer to switch between 384 and 96 channel heads if desired. A pipetting motor located within the carriage 22 drives the multi-channel pipetting head to aspirate and dispense. A Z-axis vertical drive mechanism moves the carriage 22 and the multi-channel pipetting head vertically with respect to the tower 24 and the deck 17. An X-axis drive mechanism moves the tower 24 and the carriage 22 horizontally along an X-axis so that the pipetting head and the array of tips 14 can be moved over the right-side nesting receptacle 17 on the deck 16 or over the left-side nesting receptacle 21 on the deck 17.

The system 11 includes a control handle 15 mounted to the carriage 22 and resembling the handle 16 of the handheld electronic pipette 10 depicted in FIG. 1A. In use, the user grasps the control handle 15 in a manner similar as when using a handheld pipette and exerts pressure on the control handle 15 to move the carriage 22 and the pipetting head. The vertical Z-axis motion and the horizontal X-axis motion are driven by independent motors under servo control. The control handle 15 in system 10 also includes a user interface for controlling pipetting functions such as aspirating and dispensing.

To mount the pipette tips, the pipetting head with the array of tip mounting shafts is aligned precisely over the tip rack 20 located on deck 17 using the X-axis horizontal drive mechanism. Then, the Z-axis vertical drive mechanism is used to lower the carriage 22 and the tip mounting shafts 12 with sufficient force to attach the array of pipette tips 14 held in the pipette tip rack 20. The carriage 22 and the pipetting head are then raised using the Z-axis vertical drive mechanism to remove the tips 14 from the tip rack 20. The tip rack 20 is removed from the nesting receptacle 21 on the deck 16 and replaced with a well plate or reservoir in order to transfer fluids.

For tip attachment as with regular motion control, the general horizontal and vertical motion of the carriage 22 and pipetting head is controlled by the user by holding the controller 15 in their palm and applying pressure in the appropriate direction to position the pipetting head over the rack 20 of pipette tips 14. Biasing motion control software can be used to achieve precise alignment necessary for tip attachment. Once the pipetting head and the tip mounting shafts 12 are aligned, the handle control 15 is disabled and an automated tip attachment routine is used to provide sufficient downward force to attach the tips 14 to the mounting shafts 12. As a safety precaution, the automated tip attachment routine can be activated only when one of the user’s hands depresses the button 25 on the top of the carriage 22 and the other hand is detected to be present on the handle 16.

Once the tips 14 are mounted, internal components in the carriage 22 drive pistons that each extend through a seal assembly to displace air within an aspiration and dispensing cylinder. The tip mounting shafts 12 are attached to the pipetting head such that each shaft is in fluid communication with one of the aspiration and dispensing chambers. The user interface on the handle 15 includes thumb wheel control, run button and a display. The handle 15 also includes a lever or ejection button 27 that is pushed downward to activate downward movement of an ejection plate on the pipette head. The ejection plate is desirably stepped so that the tips are ejected in stages thereby reducing the required ejection force.

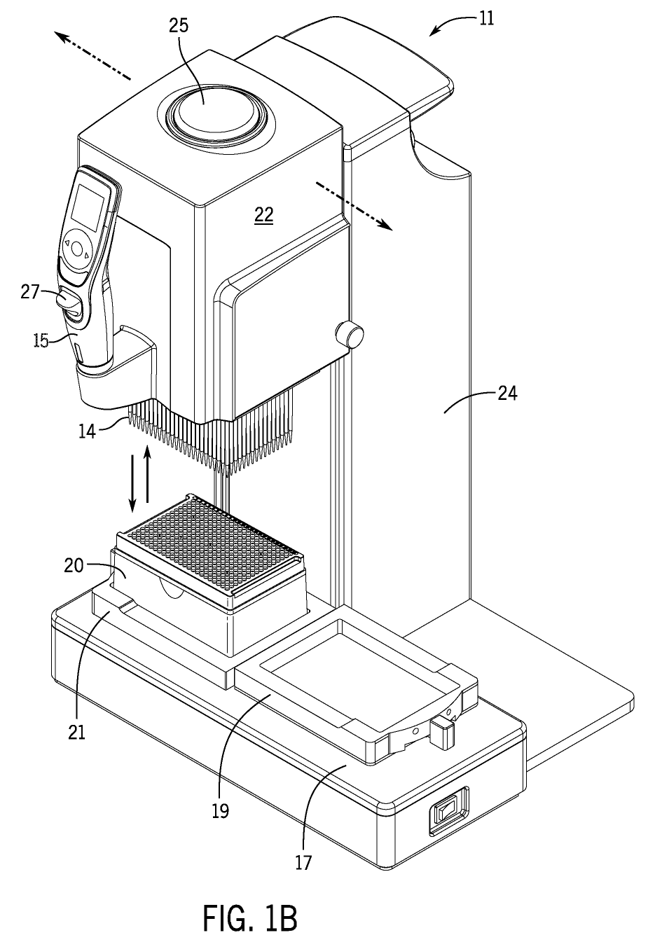

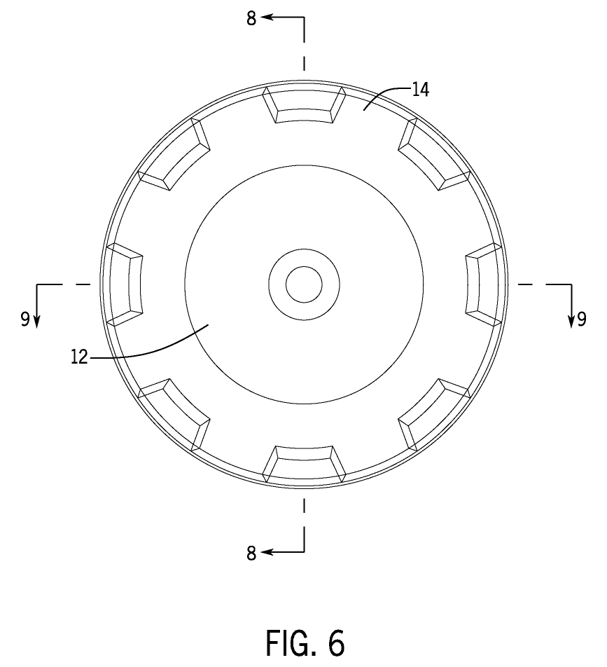

As shown in FIG. 2, the mounting shaft 12 includes a plurality of mounting protrusions 26 for attaching it to the lower end of the aspiration and dispensing cylinder (not shown) on the pipetting head of the robotic liquid handling system 11, or the handheld pipette 10. In FIGS. 2 through 11C, as in the incorporated, co-pending ’304 and ’382 applications, the dimensions of the mounting shaft 12 match the dimensions of the pipette tip 14 so that only pipette tips 14 with the proper dimensions fit onto the mounting shaft 12 and engage properly. For example, even if the pipette tips are constructed in accordance with the invention, if one chooses to use pipette tips with a different bore dimension in the collar or sealing region, it is necessary to replace the pipetting head with a new pipetting head with mounting shafts 12 having appropriate dimensions for the tips 14 being mounted and used.

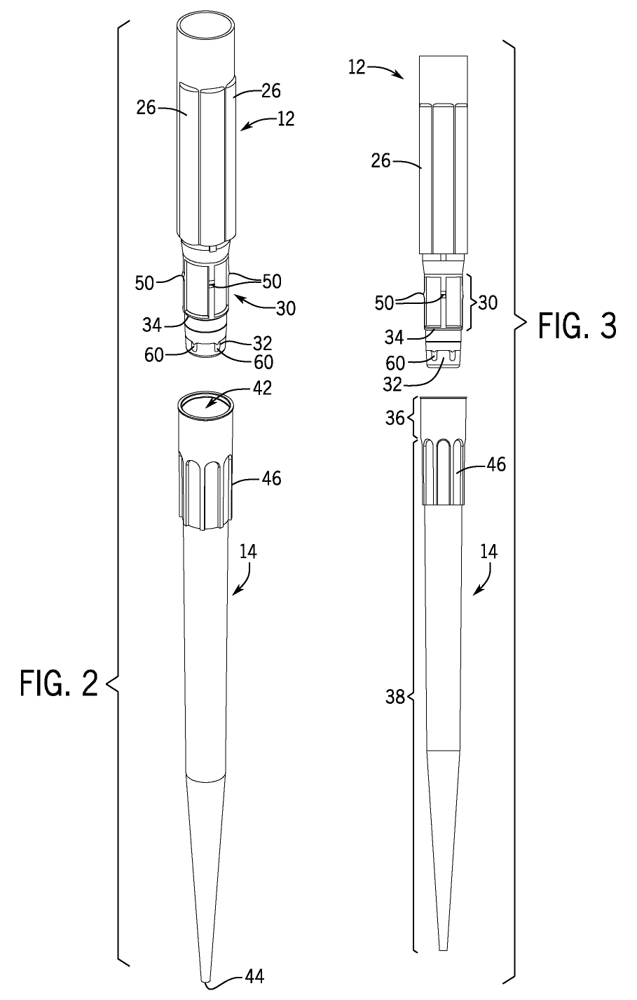

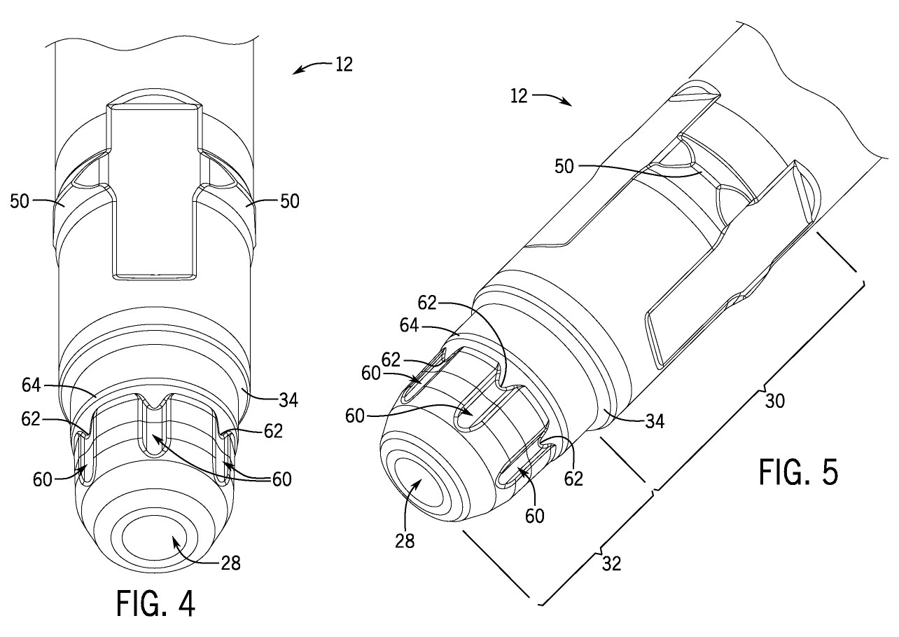

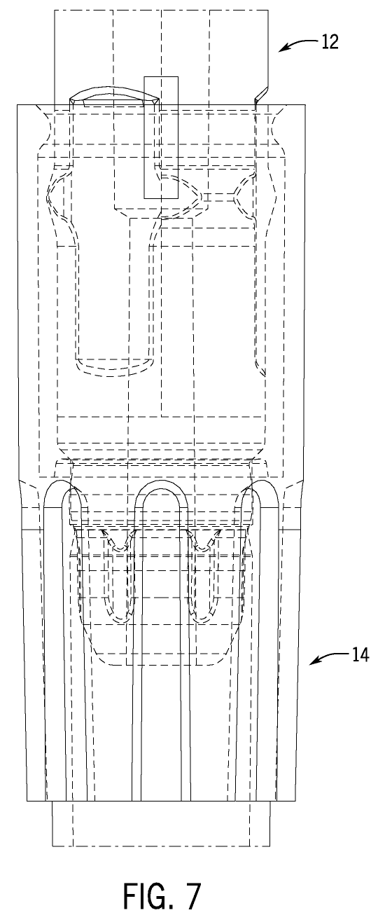

Referring now in general to FIGS. 2-11C, the mounting shaft 12 contains a central bore 28 (FIGS. 4-5) for air to pass between the aspiration and dispensing cylinder in the pipette 10 and the pipette tip 14, as is well known in the art. FIG. 7, e.g., is a transparent side elevational view of the pipette tip 14 and tip mounting shaft 12 at the onset of sealing.

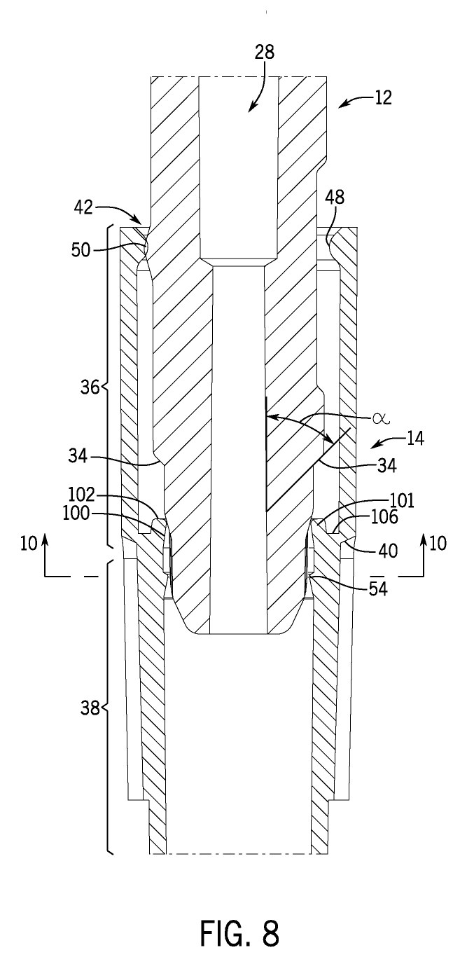

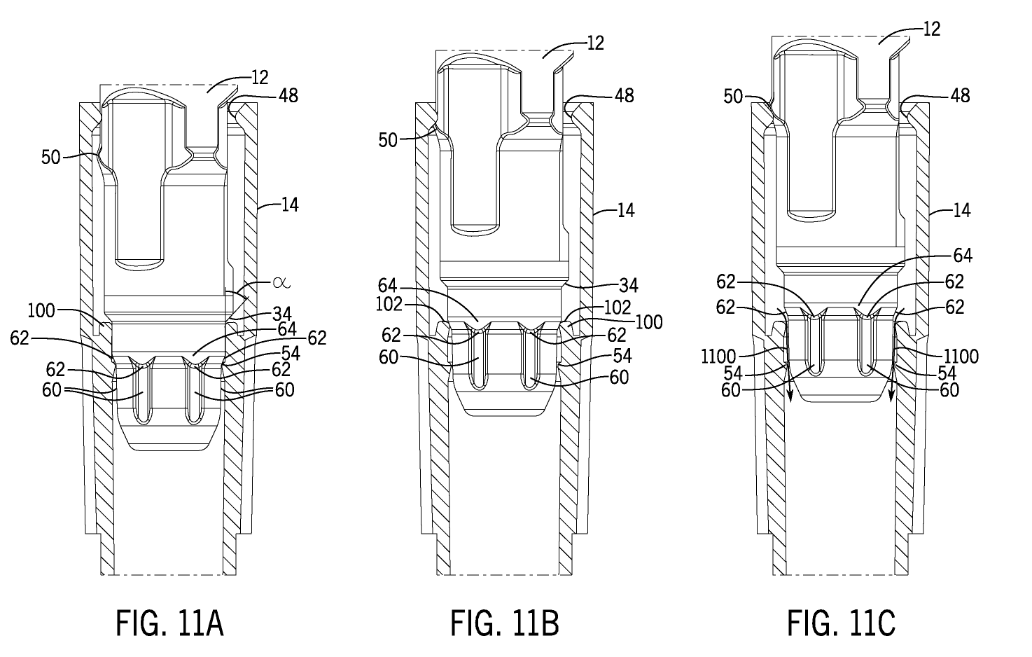

Referring specifically to FIGS. 4 and 5, the pipette mounting shaft 12 includes an upper locking section 30, a lower section 32, and a stop 34 located between the upper locking section 30 and the lower section 32. The locking section 30 of the mounting shaft 12 has multiple outwardly extending locking lobes 50. the mounting shaft 12 according to the present invention is shown to include multiple venting grooves 60 formed in the lower section 32. Each of the venting grooves 60 is shown to terminate in a lip 62 proximate a venting stop surface 64 located below the stop 34. As specifically depicted in FIG. 8, in some embodiments, an angle α of the stop 34 relative to a longitudinal axis of the mounting shaft 12 is approximately 45°. However, in other exemplary embodiments, angle α may range from 45° to 110°, and more preferably, from 90° to 110°, to ensure secure engagement with the pipette tip 14. As described in further detail below with regards to FIGS. 11A-11C, the venting grooves 60 are configured to contact sealing features within the pipette tip 14 such that the grooves permit a flow of air to enter the sealing region during a tip ejection procedure.

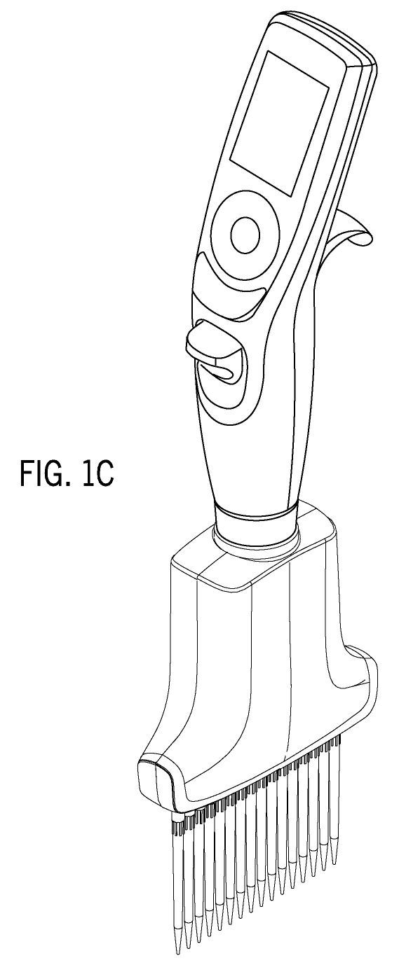

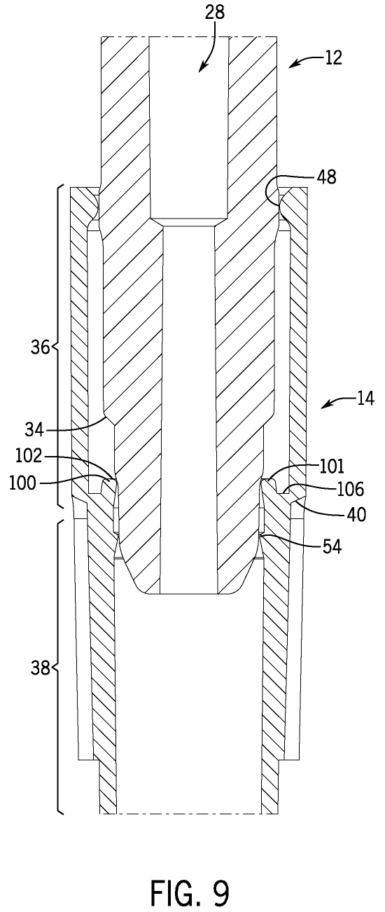

The pipette tip 14 generally consists of a collar 36, a barrel 38, and a circumferential shoulder 40 (see e.g., FIGS. 8 and 9) that extend around the inside bore of the tip 14 and connects the lower end of the collar 36 to the upper end of the barrel 38. The upper end of the collar 36 has an opening 42 to receive the pipette mounting shaft 12. The lower end of the barrel 38 has a small opening 44 (see FIG. 2) through which liquid is aspirated into the tip barrel 38 and dispensed from the tip barrel 38 during normal operation of the pipette 10. Support ribs 46 (see FIGS. 2 and 3) extend downward on the outside surface of the disposable tip 14 from the collar 36. The support ribs 46 function to hold the tip 14 or an array of tips 14 in a rack for subsequent use and mounting, as is known in the art.

Referring to FIGS. 8 and 9, an upper locking and stabilization ring 48 is located on the inside surface of the collar 36 of the pipette tip 14. The upper locking and stabilization ring 48 is located at or slightly below the opening 42 in the collar 36 through which the mounting shaft 12 is inserted. The upper locking and stabilization ring 48 extends inward from the inside wall of the collar a slight amount, e.g. in the range of 0.025 to 0.25 mm, in order to provide an over-center, fit over locking lobes 50 on the mounting shaft 12 (see FIG. 8) during the tip insertion/ejection process, and haptic feedback to a user once the locking lobes 50 have traveled over the upper stabilization ring 48 in both insertion and ejection. For example, during ejection, the upper locking and stabilization ring 48 is sufficiently flexible to distort outwardly and ensures low resistance travel of the tip 14 until reaching the lobes 50. The distortion of the ring 48 builds up potential energy as the lobes 50 travel over the ring 48. This potential energy is released into kinetic energy as the ring 48 passes the largest diameter peaks of the lobes 50. The inside surface of the collar 36 is preferably slightly tapered or slightly frustoconical but can also be cylindrical. The preferred taper is between 0° and 10°. In any event, horizontal cross-sections through the main section of the collar 36 are circular.

As mentioned, the circumferential shoulder 40 on the tip 14 connects the lower end of the collar 36 to the upper end of the barrel 38. A circular cantilever sealing ring 100 includes a resilient annular wall 101 that extends from the tip shoulder 40 towards the collar opening 42. The purpose of the laterally resilient annular wall 101 is to laterally engage and seal against the lower sealing section 32 of the mounting shaft 12 including the venting grooves 60. The annular wall 100 has an upper free end 102 that abuts the stop 34 on the pipette mounting shaft 12 when the tip 14 is fully mounted to the mounting shaft 12. This lateral seal is sometimes referred to as a reverse cup seal.

The collar 36 of the disposable pipette tip 14 is sufficiently flexible to distort outwardly at the lobes 50 on the mounting shaft 12 and inwardly between the lobes 50 when the pipette tip 14 is mounted on the tip mounting shaft 12. However, the circumferential shoulder 40 has sufficient structural integrity to maintain roundness of the circular cantilever sealing ring 100 so that an inside surface 104 of the of the annular wall 101 seals laterally against the lower sealing section 32 of the mounting shaft 12.

The circumferential shoulder 40 as shown in FIGS. 8 and 9 is continuous around the circumference of the tip 14. The shoulder 40 is shown to be angular in cross section, however, it need not be angular. The circumferential shoulder 40 provides structural integrity that serves to separate and isolate the distortion of the collar 36 from the circular cantilever sealing ring 100. The collar 36 is distorted out-of-round when the mounting shaft 12 is inserted into the pipette tip 14. The circumferential shoulder 40 of the tip 14 isolates the circular cantilever sealing ring 100 from any distortion, thereby facilitating an effective lateral seal between the inside surface 104 of the annular wall 101 of the circular sealing ring 100 on pipette tip 14 and the lower sealing section 32 on the mounting shaft 12, see incorporated ’304 and ’832 applications.

To accurately locate the mounting height of the tip 14 on the mounting shaft 12 when the tip 14 is fully mounted to the mounting shaft 12, the stop 34 on the mounting shaft 12 engages the top edge 102 of the annular wall 101 of the circular cantilever sealing ring 100 (see FIG. 11A). As described above, angle α of the stop 34 may range from 45° to 110°, and more preferably, from 90° to 110°, to ensure secure engagement with the top edge 102 of the annular wall 101. With multi-channel devices, this configuration ensures the same vertical mounting distance from tip to tip, which facilitates precise and consistent tip positioning during pipetting. When the tip 14 is in a relaxed state, the inside circumferential surface 104 of the annular wall 101 angles slightly inward as the annular wall 100 extends upward towards the collar opening 42. The slight inward slant provides a lateral interference fit between the inside surface 104 of the annular wall 101 and the lower sealing section 32 of the mounting shaft 12 when the mounting shaft 12 is fully inserted. In a preferred embodiment, the amount of interference ranges from 0.05 to 0.11 mm. The annular wall 101 extends upward above the circumferential shoulder 40 such that there is a gap 106 between the annular wall 101 and the collar sidewall 36. The gap 106 enables the annular wall 100 to pivot outward laterally when the pipette mounting shaft 12 is inserted into the tip 14. The inside diameter of the tip immediately below the annular wall 101 is selected to have zero interference with the mounting shaft 14. Rather, the lateral interference fit of the annular wall 101 of the circular cantilever sealing ring 100 above the shoulder 40 of the tip 14 provides the sealing engagement of the tip 14 to the mounting shaft 12.

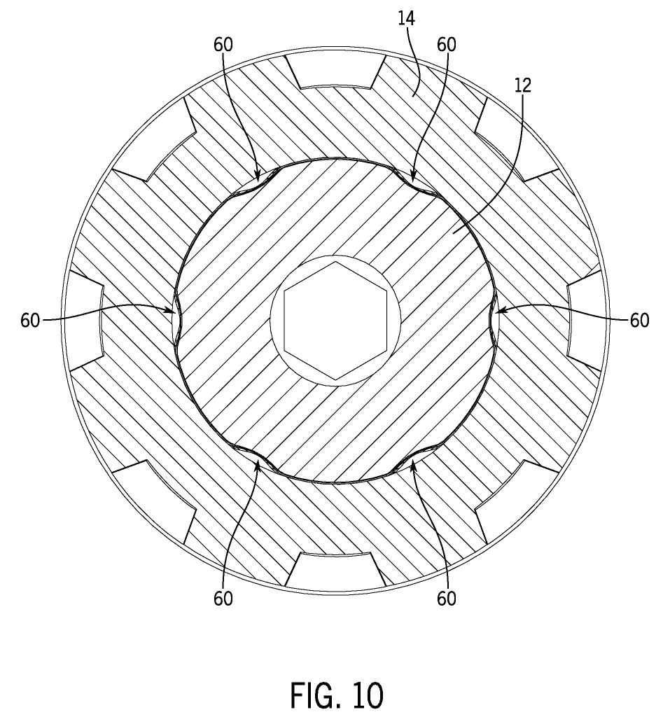

FIG. 10 depicts a bottom cross-sectional view of the mounting shaft 12 and the pipette 14 taken along the line F-F of FIG. 8. As shown, multiple venting grooves 60 are distributed about the perimeter of the mounting shaft 12. In an exemplary embodiment, the mounting shaft 12 is shown to include six venting grooves 60 equally distributed from each other (i.e., 60° apart ). In other embodiments, the mounting shaft 12 may include a different number of mounting grooves 60, including a single mounting groove 60, or an unequal spacing of the grooves 60. The number and dimensions of the grooves 60 may be configured such that the dynamic flow resistance across all the grooves 60 is equal to or less than the dynamic flow resistance through the tip orifice 44. The depth of the grooves 60 may be configured to ensure that a minimum wall thickness (e.g., 0.3 mm) is maintained, and the distance between the grooves may be configured to ensure that sufficient surface area remains between the grooves to stabilize the pipette tip 14 on the mounting shaft 12.

FIGS. 11A through 11C illustrate stages of the ejection of the pipette tip 14 from the mounting shaft 12. FIG. 11A is a drawing showing a mounting shaft 12 and pipette tip 14 configured in accordance with the first embodiment of the invention with the mounting shaft 12 and the pipette tip 14 in a sealed configuration prior to ejection. As shown, the locking lobes 50 on the mounting shaft 12 are located approximately 1-3 mm below the upper locking and stabilizing ring 48 on the inside surface of the tip collar 36, and the upper locking and stabilizing ring 48 abuts the shaft 12. More particularly, stop 34 on the mounting shaft 12 contacts the cantilevered circular seal 100 on the pipette tip in FIG. 11A. Lower stabilizing ring 54 in the barrel of the tip 14 maintains alignment of the tip 14 against the lower part of the mounting shaft 12 in the region of the shaft proximate the grooves 60. The lower stabilizing ring 54 ensures that that the tip 14 is stabilized in the X-Y plane (i.e., a plane perpendicular to the longitudinal axis of the mounting shaft 12) by abutting the shaft 12 along with the upper stabilizing ring 48. The lower stabilization ring 54 does not seal against the venting stop 64 or the terminating lips 62 of the venting grooves 60, even though FIGS. 11A and 7 show the lower stabilization ring 54 in the vicinity of the venting stop 64 when the tip is fully mounted. In accordance with invention, the lower stabilization ring 54 can be located relatively further downward along the mounting shaft 12 such that it supports the mounting shaft 12 at the height of the grooves 60.

FIG. 11B is a view similar to FIG. 11A in which ejection of the pipette tip 14 from the mounting shaft 12 has commenced. The ejection process as the pipette tip 14 travels from the fully sealed configuration depicted in FIG. 11A to the position depicted in FIG. 11B is a slow and controlled movement. Locking lobes 50 on the mounting shaft 12 are shown to butt up against the upper stabilizing ring 48 on the inside surface of the tip collar 36, and there is space between stop 34 on the mounting shaft 12 and the upper surface 102 of the cantilevered circular seal 100. Terminating lips 62 of venting grooves 60 and venting stop 64 contact the cantilevered circular seal 100, thereby breaking the seal formed in the lower sealing section 32 of the mounting shaft 12 as air is permitted to enter between the cantilevered circular seal 100 and the terminating lips 62.

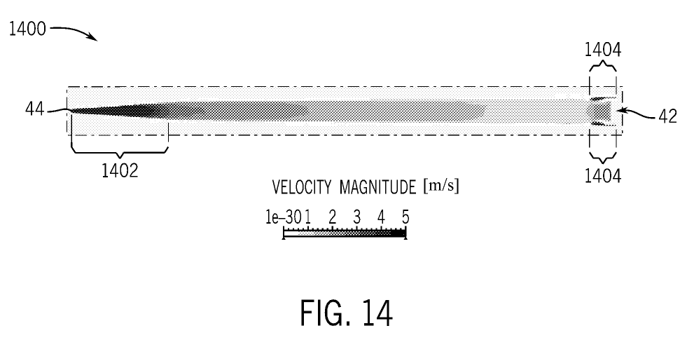

FIG. 11C depicts a stage in the ejection of the pipette tip 14 from the mounting shaft 12 in which air is permitted to enter the pipette tip 14 via the venting grooves 60 in the mounting shaft 12. By the stage of ejection depicted in FIG. 11C, the locking lobes 50 are shown to be above the upper stabilizing ring 48 on the inside surface of the tip collar 36, and haptic feedback is provided to the user as the upper stabilizing ring 48 travels over the locking lobes 50. Such haptic feedback may prompt a user to apply more force to the pipette tip 14 to facilitate ejection. In addition, the terminating lips 62 and venting stop 64 are shown to be positioned above the cantilever circular seal 100. In this way, a flow of air represented by arrows 1100 is permitted to flow from the region surrounding the upper stabilizing ring 48, past the stop 34 and between the venting grooves 60 and the circular seal 100, thereby reducing the formation of an under-pressure region within the tip 14 during ejection and reducing the speed of air velocity through the tip orifice (see FIG. 14 below).

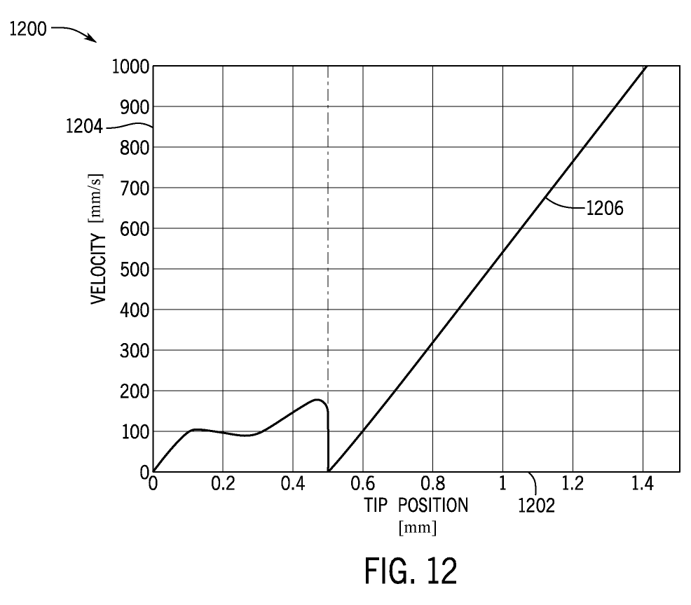

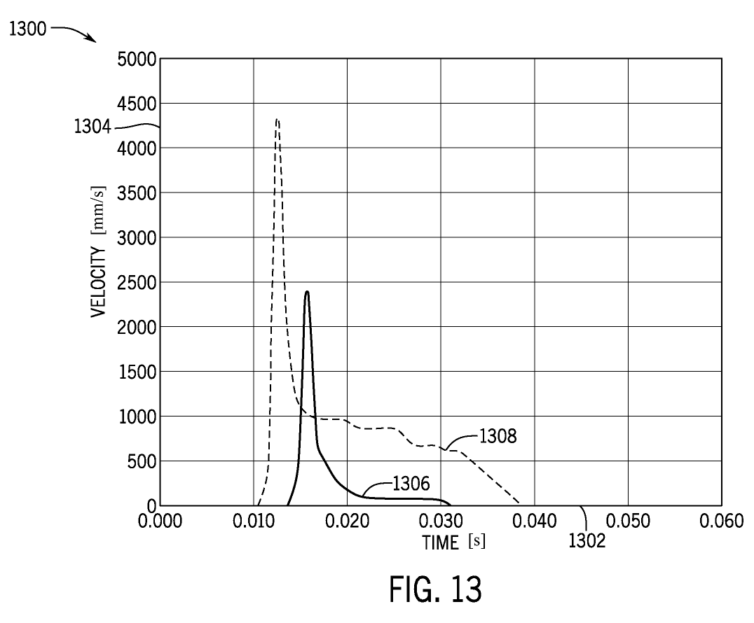

Referring now to FIGS. 12-15, several plots and diagrams depicting the advantages of the mounting shaft 12 including the venting grooves 60 are shown. FIG. 12 depicts a plot 1200 illustrating the velocity of a pipette tip 14 (trendline 1206) as it is ejected from mounting shaft 12. Horizontal axis 1202 depicts the distance that the tip 14 has moved from its sealed configuration in units of millimeters, while vertical axis 1204 depicts the velocity of the tip 14 in units of millimeters per second. As shown, as the tip 14 moves 0.5 mm from the sealed configuration (i.e., tip position = 0 mm, see FIG. 11A) to the breaking of the seal between the mounting shaft 12 and the tip 14 (i.e., tip position = 0. 5 mm, see FIG. 11B), the travel speed of the tip 14 does not exceed 200 mm/s, and is therefore controlled and non-explosive. Following the breaking of the seal between the mounting shaft 12 and the tip 14 (i.e., tip position > 0.5 mm, see e.g., FIG. 11C), the travel speed of the tip 14 accelerates to reach speeds in excess of 1,000 mm/s. In some embodiments, the travel speed of the tip 14 can reach a maximum speed of about 2,500mm/s (see FIG. 13 below).

FIG. 13 depicts a plot 1300 illustrating the comparable velocities of pipette tips 14 as they are ejected from a mounting shaft 12 that does contain venting grooves 60 (trendline 1306) and from a prior art mounting shaft that does not contain venting grooves (trendline 1308). Horizontal axis 1302 depicts the time after ejection is initiated in units of seconds, while vertical axis 1304 depicts the velocity of the tip 14 in units of millimeters per second. As shown, after initiating ejection, the seal between the pipette tip 14 and the mounting shaft 12 including the venting grooves 60 breaks around 0.012 seconds and a maximum tip speed of about 2,500 mm/s occurs around 0.016 seconds. This peak velocity occurs for only a short period of time as the tip speed drops back below 500 mm/s around 0.018 seconds after ejection. By contrast, sealing between pipette tip 14 and a mounting shaft similar to mounting shaft 12 but not including the venting grooves breaks around 0.010 seconds after ejection is initiated and peaks at a value of approximately 4,400 mm/s around 0.012 seconds after ejection is initiated. Although the tip velocity drops below 1,000 mm/s around 0.015 seconds after ejection is initiated, the velocity of the tip ejected from the mounting shaft without the venting grooves remains higher for a longer period of time than that of the tip ejected from the shaft 12 including the venting grooves 60, only dropping below 500 mm/s around 0.033 seconds after ejection is initiated. Thus, it is seen that the ejection of the tip from the shaft 12 including the venting grooves 60 is less explosive than ejection of the tip from a comparable shaft not containing venting grooves, and formation of aerosols at the tip orifice 44 is less likely to occur.

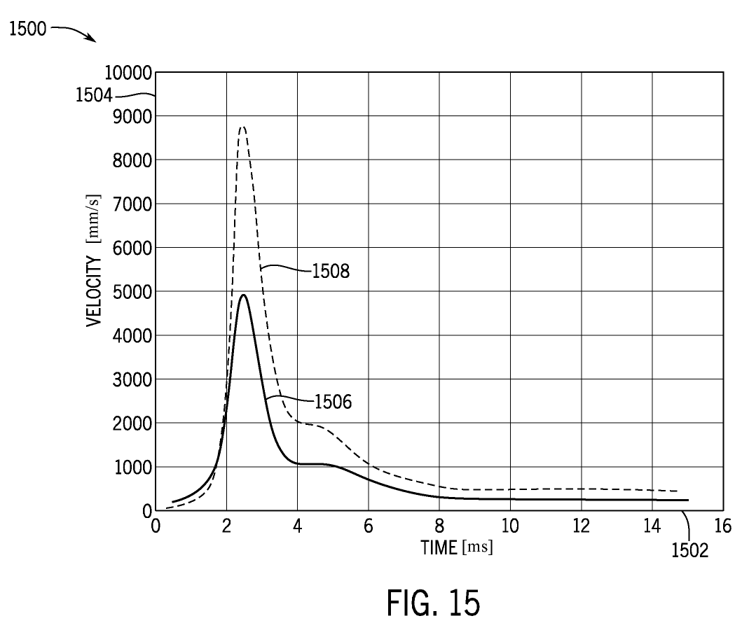

This advantageous result is further illustrated in the diagram 1400 of FIG. 14 depicting calculated air flow velocities through a pipette tip 14 as it is ejected from a mounting shaft 12 including venting grooves 60. As shown, a region of high air velocity 1402 proximate the tip orifice 44 is created, with maximum air velocities reaching approximately 5,000 mm/s. Additional regions of high air velocity 1404 are shown in the region near the collar opening 42 of the pipette tip 14, where air is permitted to enter the tip 14 via the venting grooves in the mounting shaft 12. FIG. 15 depicts a plot 1500 illustrating the comparable velocities of air entering the orifice of pipette tips 14 ejected from a mounting shaft 12 including the venting grooves 60 (trendline 1506) and from a mounting shaft not including the venting grooves (trendline 1508). Horizontal axis 1502 depicts the time after ejection in initiated in units of milliseconds, while vertical axis 1504 depicts the air velocity entering the orifice of the tips in units of millimeters/second. As shown, the maximum air velocity of the air entering the tip ejected from the shaft 12 including the venting grooves 60 is significantly reduced (i.e., approximately 5,000 mm/s) as compared with the velocity of the air entering the tip ejected from the shaft not including the venting grooves (i.e., approximately 9,000 mm/s). This significant reduction in air velocity at the orifice of the tip when a mounting shaft with venting grooves is utilized significantly reduces the formation of aerosols at the tip orifice.

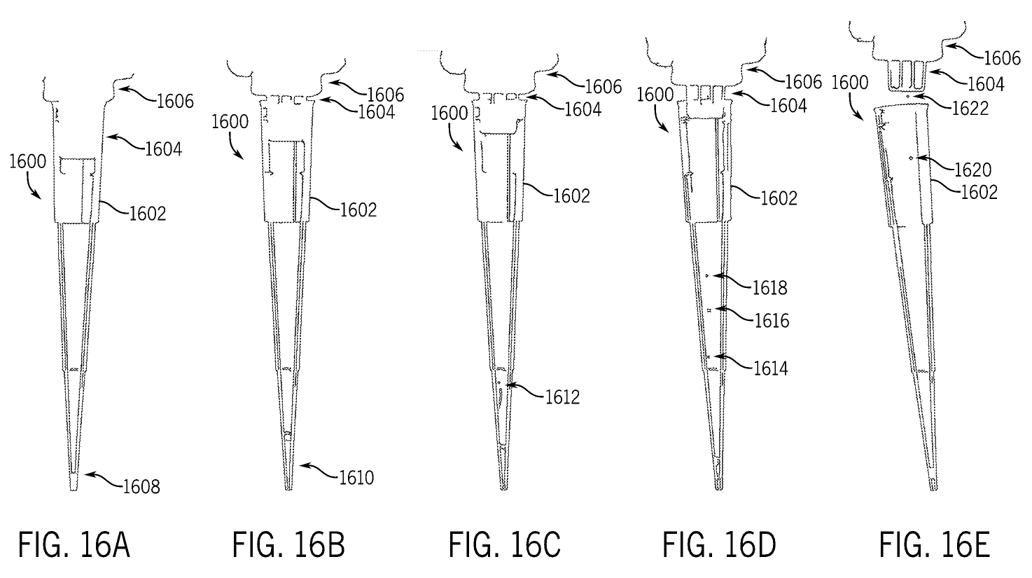

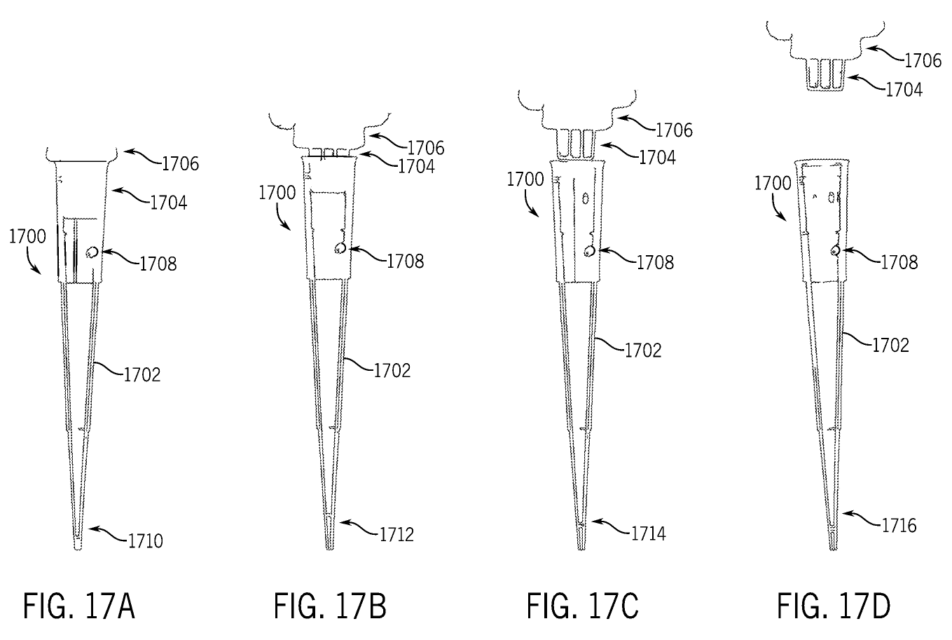

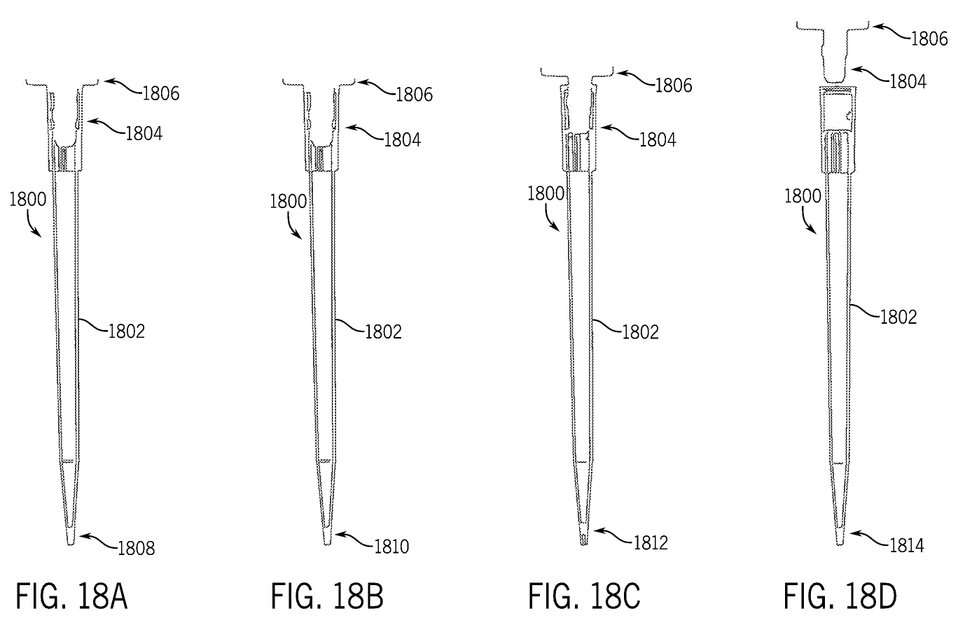

FIGS. 16A-16E, 17A-17D and 18A-18D respectively depict comparative series of ejection operation tests for a prior art friction fitted pipette system 1600 (FIGS. 16A-16E), the prior art friction fitted pipette system 1700 modified to include a venting hole 1708 in the collar of the pipette tip 1702 (FIGS. 17A-17D), and a pipette system 1800 according to the systems and methods of the present disclosure (FIGS. 18A-18D). Tests were completed utilizing liquid water dyed with blue food coloring to readily observe the formation of microdroplets and aerosols during the ejection operations.

The prior art friction fitted pipette system 1600 depicted in FIGS. 16A-16E includes the pipette tip 1602, mounting shaft or tip fitting 1604, and ejection plate 1606, the operation of which act to separate the pipette tip 1602 from the tip fitting 1604. Prior to commencement of the ejection operation (FIG. 16A), a small amount of fluid indicated by fluid level 1608 is shown to be retained within the tip 1602 opposite the tip fitting 1604. As captured approximately 2.9 milliseconds after the initiation of the ejection procedure (FIG. 16B) and 4.7 milliseconds after initiation of ejection (FIG. 16C), the fluid travels upwardly within the tip 1602, carried by inrushing air through the orifice as it moves downwardly, as indicated by fluid positions 1610 and 1612, respectively. Approximately 8.8 milliseconds after the initiation of ejection (FIG. 16D), the fluid is shown to separate into microdroplets 1614, 1616, 1618 within the tip 1602. At approximately 14.5 milliseconds after the initiation of ejection (FIG. 16E), and once the tip 1602 has fully separated from the fitting 1604, liquid microdroplets 1620, 1622 are shown to be ejected from the tip 1602 in the vicinity of the fitting 1604, thus posing a risk of contamination of the fitting.

Improvements in preventing the formation of microdroplets were observed in the friction fitted pipette system 1700 depicted in FIGS. 17A-17D. In contrast to the pipette system 1600, pipette system 1700 features a pipette tip 1702 with a single vent hole 1708 drilled within the collar portion of the tip. The hole was covered by an adhesive film to allow aspiration and liquid dispensation; the film was then removed just prior to tip ejection. No modifications were made to the tip fitting 1704 or ejection plate 1706. Prior to commencement of the ejection operation initiated via movement of ejection plate 1706 (FIG. 17A), a small among of fluid indicated by fluid level 1710 is shown to be retained within the tip 1702 opposite the tip fitting 1704. As captured approximately 4.0 milliseconds (FIG. 17B) and 9.4 milliseconds (FIG. 17C) after initiation of the ejection procedure, the fluid travels somewhat upwardly within the tip 1702, as indicated by fluid positions 1712 and 1714, respectively. At approximately 20.3 milliseconds after the initiation of ejection (FIG. 17D), and once the tip 1702 has fully separated from the fitting 1704, the fluid is retained within the tip 1702 opposite the tip fitting 1704 and no formation of microdroplets was observed in the vicinity of the fitting 1704.

Additional improvements were observed in the pipette system configured according to the systems and methods of the present disclosure. Rather than a vent hole incorporated into the tip 1802, venting grooves are formed into the tip fitting 1804, for example, as depicted and described above with reference to FIGS. 2-11C. Prior to commencement of the ejection operation initiated via movement of ejection plate 1806 (FIG. 18A), a small amount of fluid indicated by fluid level 1808 is shown to be retained within the tip 1802 opposite the tip fitting 1804. As captured approximately 1.7 milliseconds (FIG. 18B) and 5.0 milliseconds (FIG. 18C) after initiation of the ejection procedure, the fluid travels minimally upwardly within the tip 1802, as indicated by fluid positions 1810 and 1812, respectively. At approximately 15.7 milliseconds after the initiation of ejection (FIG. 18D), and once the tip 1802 has fully separated from the fitting 1804, the fluid is retained within the tip 1802 opposite the tip fitting 1804 and no formation of microdroplets was observed in the vicinity of the fitting 1804.

It should be understood by those skilled in the art that while exemplary embodiments of the invention have been described in connection with the drawings, various aspects and features of the invention can be implemented in other forms.

What is claimed is:

1. A pipette system comprising a tip mounting shaft and a disposable pipette tip, wherein the tip mounting shaft comprises:
an upper locking section having a stop and a lower sealing area located below the stop, and a shaft head contiguous with the lower sealing area, wherein the lower sealing area provides a circumferential sealing surface, and the shaft head comprises one or more of grooves formed therein; and
the disposable pipette tip comprises:
a barrel having a lower opening through which liquid is aspirated into the barrel and dispensed from the barrel, wherein the diameter of the lower opening is less than the diameter of the barrel at an upper end of the barrel;
a collar having a continuous inner surface with a circular circumference in its relaxed state, an upper opening for receiving the tip mounting shaft, and a lower end with an inside diameter that is larger than an inside diameter of the upper end of the barrel;
a circumferential tip shoulder connecting the lower end of the collar to the upper end of the barrel; and
means for sealing against the lower sealing area proximate the one or more grooves on the mounting shaft below the stop on the mounting shaft; wherein the one or more of grooves are configured to permit a flow of air to enter into the pipette tip barrel through the upper opening in the collar during an ejection process of the pipette system.

2. The pipette system of claim 1, wherein the one or more grooves comprises a plurality of grooves positioned at intervals circumferentially about the lower sealing area.

3. The pipette system of claim 2, wherein the plurality of grooves are positioned at equal intervals circumferentially about the lower sealing area.

4. The pipette system of claim 2, wherein the plurality of grooves comprises six grooves positioned at 60° intervals circumferentially about the lower sealing area.

5. The pipette system of claim 1, wherein an angle of the stop relative to a longitudinal axis of the tip mounting shaft ranges from 45° to 110°.

6. The pipette system of claim 1, wherein said sealing means for sealing against the lower sealing area proximate the one or more grooves comprises a circular cantilever sealing ring having an annular wall extending from the tip shoulder toward the collar opening for laterally engaging and sealing against the lower sealing area of the mounting shaft when the tip is fully mounted to the mounting shaft, said annular wall having a top edge that abuts the stop on the tip mounting shaft when the tip is fully mounted to the shaft.

7. The pipette system of claim 6, wherein each of the one or more grooves terminates in a lip positioned below the stop that laterally engages the circular cantilever sealing ring.

8. The pipette system of claim 7, wherein the disposable pipette tip further comprises a circumferential stabilization ring encircling the inside surface of the barrel and extending inward from the inside surface of the barrel, said circumferential stabilization ring being located below said sealing means for sealing the disposable pipette tip.

9. The pipette system of claim 8, wherein the circumferential stabilization ring of the pipette tip abuts mounting shaft around the one or more grooves or at the terminating lip of the grooves to stabilize but does not seal against the tip when the tip is fully mounted to the shaft.

10. The pipette system of claim 1, wherein the upper locking section of the tip mounting shaft further comprises a plurality of outwardly extending lobes, and wherein the pipette tip further comprises an upper locking and stabilization ring extending inward from the continuous inner surface of the collar to engage the lobes, said upper stabilization ring extending around the entire circumference of the collar or substantially around the entire circumference of the collar and located at a rim of the upper opening of the collar and above the circumferential tip shoulder.

11. The pipette system of claim 10, wherein the collar of the disposable pipette tip is sufficiently flexible to distort outwardly at the lobes on the mounting shaft, and further when the disposable pipette tip is ejected from the tip mounting shaft, the locking ring in the collar of the disposable pipette tip engages the lobes and clears the peaks of the lobes to provide haptic feedback to a user.

12. The pipette system of claim 11, wherein the upper locking and stabilization ring is configured to abut the mounting shaft above the lobes when the tip is fully mounted to the shaft.

13. A disposable pipette tip for a pipette system comprising a disposable pipette tip and a tip mounting shaft, the tip mounting shaft having an upper locking section having a stop and a lower sealing area located below the stop, and a shaft head contiguous with the lower sealing area, wherein the lower sealing area provides a circumferential sealing surface, and the shaft head comprises one or more of grooves formed therein, the disposable pipette tip comprising:
a barrel having a lower opening through which liquid is aspirated into the barrel and dispensed from the barrel, wherein the diameter of the lower opening is less than the diameter of the barrel at an upper end of the barrel;
a collar having a continuous inner surface with a circular circumference in its relaxed state, an upper opening for receiving the tip mounting shaft, and a lower end with an inside diameter that is larger than an inside diameter of the upper end of the barrel;
a circumferential stabilization ring encircling the inside surface of the barrel and extending inward from the inside surface of the barrel;
an upper locking and stabilization ring extending inward from the continuous inner surface of the collar, wherein the upper locking and stabilization ring is configured to engage a plurality of outwardly extending lobes on the upper locking section of the tip mounting shaft;
a circumferential tip shoulder connecting the lower end of the collar to the upper end of the barrel; and
means for sealing against the lower sealing area proximate the one or more grooves on the mounting shaft below the stop on the mounting shaft; wherein the one or more grooves are configured to permit a flow of air to enter into the pipette tip barrel through the upper opening in the collar during an ejection process of the pipette system, wherein the circumferential stabilization ring is located below said sealing means for sealing the disposable pipette tip.

14. The disposable pipette tip of claim 13, wherein said sealing means for sealing against the lower sealing area proximate the one or more grooves comprises a circular cantilever sealing ring having an annular wall extending from the tip shoulder toward the collar opening for laterally engaging and sealing against the lower sealing area of the mounting shaft when the tip is fully mounted to the mounting shaft.

15. The disposable pipette tip of claim 14, wherein said annular wall has a top edge that abuts the stop on the tip mounting shaft when the tip is fully mounted to the shaft.

16. The disposable pipette tip of claim 13, wherein the upper locking and stabilization ring extends around the entire circumference of the collar or substantially around the entire circumference of the collar.

17. The disposable pipette tip of claim 16, wherein the upper locking and stabilization ring is located at a rim of the upper opening of the collar and above the circumferential tip shoulder.

18. The disposable pipette tip of claim 17, wherein the upper locking and stabilization ring is configured to ensure a low resistance travel of the pipette tip until reaching engagement with the plurality of outwardly extending lobes on the upper locking section of the tip mounting shaft.

19. The disposable pipette tip of claim 18, wherein the collar is sufficiently flexible to distort outwardly at the lobes on the mounting shaft, and further when the disposable pipette tip is ejected from the tip mounting shaft, the locking ring in the collar of the disposable pipette tip engages the lobes and clears the peaks of the lobes to provide haptic feedback to a user.

20. The disposable pipette tip of claim 19, wherein the upper locking and stabilization ring is configured to abut the mounting shaft above the lobes when the tip is fully mounted to the shaft; and
wherein the upper locking and stabilization ring is sufficiently flexible to distort outwardly during ejection such that potential energy from the distortion of the upper locking and stabilization ring is converted into kinetic energy as the upper locking and stabilization ring passes over the lobes on the mounting shaft.
